(19) United States
(12) Patent Application Publication
(10) Pub. No.: US 2006/0294517 A1
(43) Pub. Date: Dec. 28, 2006

(54) Network interface sharing among multiple virtual machines

(76) Inventors: Vincent J. Zimmer, Federal Way, WA (US); Michael A. Rothkman, Puyallup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/168,825

(22) Filed: Jun. 28, 2005

(51) Int. Cl. G06F 9/455

(52) U.S. Cl. 718/1

(57) ABSTRACT

Multiple virtual instances of a hardware network interface can be provided and associated with virtual machines implemented by a computer system. In one embodiment, the invention includes receiving a packet from a hardware network interface at a service processor of such a host computer system, and identifying one of the virtual machine implemented by the host computer system for which the received packet is destined. The received packet can then be forwarded to the identified virtual instance of the hardware network interface provided by the service processor, which in turn is bound to the one of the virtual machines.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field

Embodiments of the present invention relate generally to the field of machine virtualization. More particularly, embodiments of the present invention relate to a sharing a network interface among multiple virtual machines.

2. Description of the Related Art

Machine virtualization describes a configuration that allows one computing machine to act as though it were multiple machines. Each virtual machine can run a different operating system, for example, to enable a single physical machine to run applications that work with different operating systems. Furthermore, partitioning a single physical machine into several virtual machines can provide safety by isolating critical applications from others that are vulnerable to attack. The advantages, methods, and hardware used to provide machine virtualization is known in the art, as described, e.g., in Intel® Virtualization Technology for the IA-32 Intel® Architecture, which is available at http://www.intel.com/technology/computing/vptech.

To enable the virtual machines to access the network, the physical machine generally implements some intermediate layer, sometimes referred to as the virtual machine monitor layer, to manage the access of the virtual machines to the physical hardware, including the network interface. Such management functions add overhead in the form of data encapsulation and address translation that is carried out in software. One solution to this problem would be to add a separate physical network interface for each virtual machine implemented. However, this would result in extra hardware in the form of multiple network interface cards, and would complicate varying the number of virtual machines implemented.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating an example computer system architecture in which various embodiments of the present invention may be implemented;

FIG. 2 is a block diagram illustrating a prior art virtual machine implementation;

FIG. 3 is a block diagram illustrating protocol layers of a generic input/output block;

FIG. 4 is a block diagram illustrating a computer system according to one embodiment of the present invention;

FIG. 5 is a block diagram illustrating an input/output block exposed to several virtual machines according to one embodiment of the present invention;

FIG. 6 is a block diagram illustrating network interface and service processor protocol layers configured according to one embodiment of the present invention;

FIG. 7A is a flow diagram illustrating inbound packet processing according to one embodiment of the present invention;

FIG. 7B is a flow diagram illustrating outbound packet processing according to one embodiment of the present invention; and

FIG. 8 is a block diagram illustrating a service processor according to one embodiment of the present invention

### DETAILED DESCRIPTION

Example Computer System

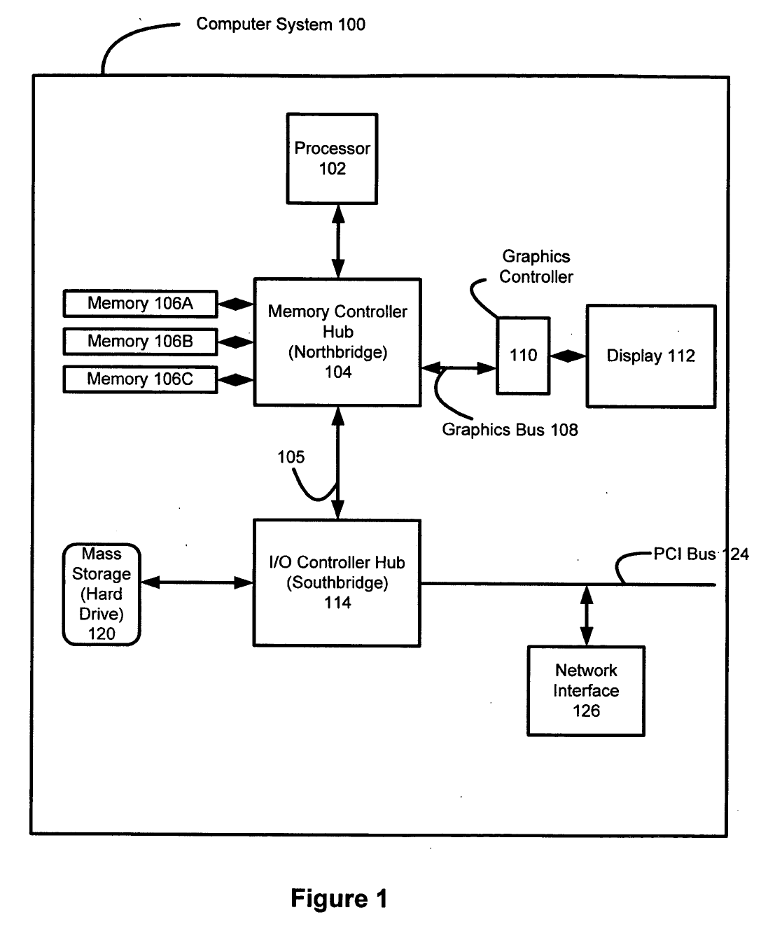

FIG. 1 illustrates an example computer system 100 - in this case a personal computer—in which various embodiments of the present invention may be implemented. However, this system is merely exemplary. Other machines in which embodiments of the present invention may be implemented include, but are not limited to various types of computing machines such as a server, client, workstation, mobile or stationary telephone, set top box, or other types of devices capable of data communication and implementing virtual machines.

In the illustrated embodiment, computer system 100 includes a memory controller hub 104 communicatively-coupled to each of a processor 102,memory 106(A-C), a graphics controller 110, and an input/output controller hub (ICH) 114. In some PC architectures, the memory controller hub 104 is sometimes referred to as the Northbridge because it provides a bridge between the host processor 102 and the rest of the computer system. In one embodiment, processor 102 comprises a high-performance notebook central processing unit (CPU) commonly used in mobile PCs. The memory system 106(A-C) is illustrative of various storage mediums used by mobile PCs. For example, memory 106A may comprise static random access memory (SRAM), while memory 106B may comprise dynamic random access memory (DRAM), and memory 106C may comprise read only memory (ROM). Graphics controller 110 is used to drive a display 112. The display 112 may typically comprise a liquid crystal display (LCD) display or other suitable display technology. Graphics controller 110 is connected to memory controller hub 104 via a graphics bus 108, such as an Accelerated Graphics Port (AGP) bus.

In one embodiment, the input/output (I/O) controller hub 114, also known in some architectures as the Southbridge, is connected to the memory controller hub 104 by a point-to-point connection 105. In other architectures, these two components may be connected via a shared bus. The I/O controller hub 114 controls the operation of a mass storage 120, such as a hard drive, and a Peripheral Component Interconnect (PCI) bus 124, amongst other things. In one embodiment, the PCI bus 124 is used to connect a network interface 126, such as a network interface card (NIC), to the computer system 100. Furthermore, the PCI bus 124 can provide various slots (not shown) that allow add-in peripherals to be connected to computer system 100.

Virtual Machines

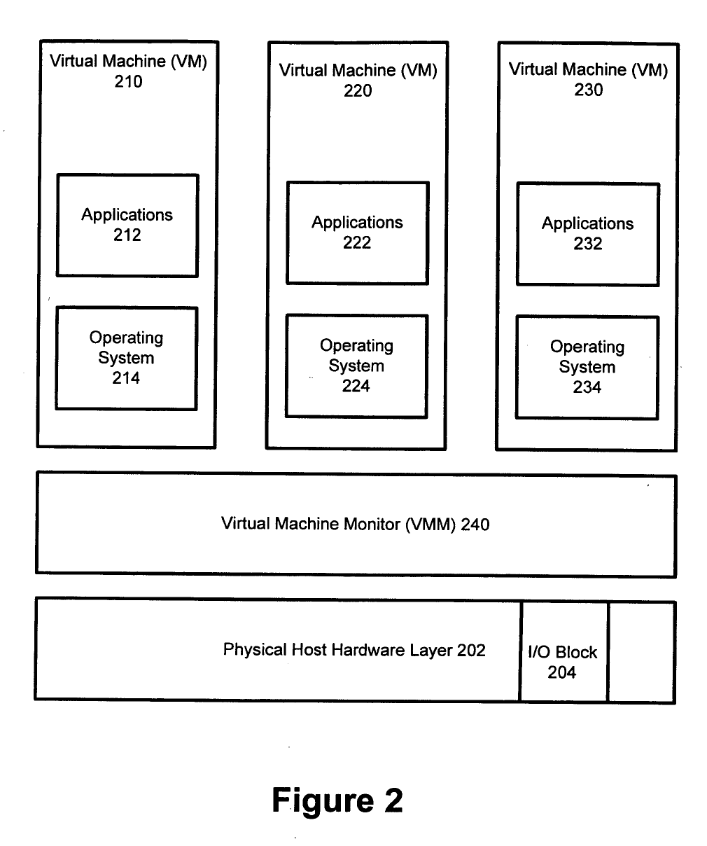

FIG. 2 is a block diagram illustrating one general configuration for implementing multiple virtual machines (VMs) in a physical computer system. The computer system includes a physical host hardware layer 202 that includes the physical hardware (connections, buses, memory, processors) and firmware needed to operate the computer system. The physical host hardware layer 202 includes an input/output block 204 used to communicate over a data network.

The computer system implements multiple VMs, as exemplified by VM 210, VM 220, and VM 230. Each VM has its own operating system (214, 224, 234, respectively), and set of applications executing over the operating system (212, 222, 232, respectively). Each VM operates in its own execution context, and is unaware that the physical host hardware layer 202 is being shared with other VMs.

To support sharing the physical host hardware layer 202 by multiple VMs, a virtual machine monitor (VMM) 240 is interposed between VMs 210, 220, and 230 and the physical host hardware layer 202. The VMM 240 is responsible for managing access to the physical host hardware layer 202. VMM 240 does this by safely multiplexing access to the platform hardware among the several operating systems within VM's, so that each operating system believes that it has sole access and control of the platform hardware. In this manner, the VMM 240 enforces isolation between the operating system VMs.

One responsibility of the VMM 240 is to manage access to the network interface connecting the computer system to a communications network. For example, such a network interface may comprise a network interface card, and is represented as an input/output (I/O) block 204 in FIG. 2.

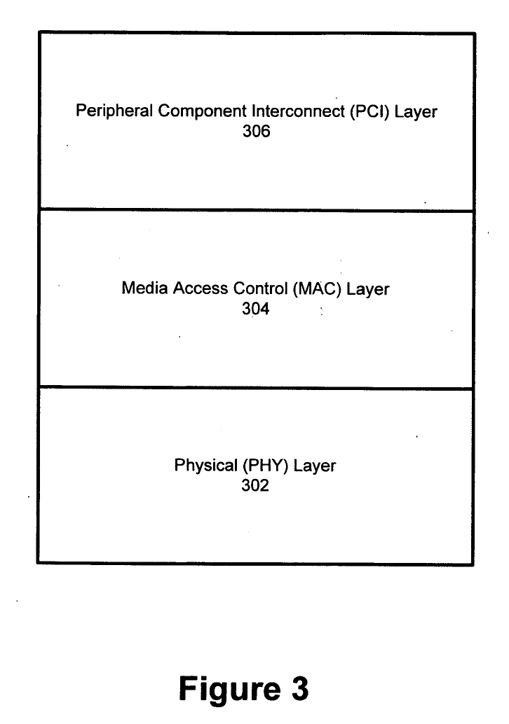

FIG. 3 is a block diagram illustrating the data flow through the input/output block 204. Data entering the I/O block from a network first passes through the Physical (PHY) layer that includes the physical wires and transceivers, where it is demodulated. The demodulated data then passes through a Media Access Control (MAC) layer 304, where packets are delineated based on an applicable protocol, such as Ethernet. Finally, MAC layer packets are processed by a Peripheral Component Interconnect (PCI) layer 306, where they undergo further processing and routing based on the PCI protocol. Under one scheme, the PCI protocol enables host CPU's, such as processor 102 in FIG. 1, to receive or transmit network-based data. Data transmitted by the computer system follows the same path in reverse.

Network Interface Sharing Using a Service Processor

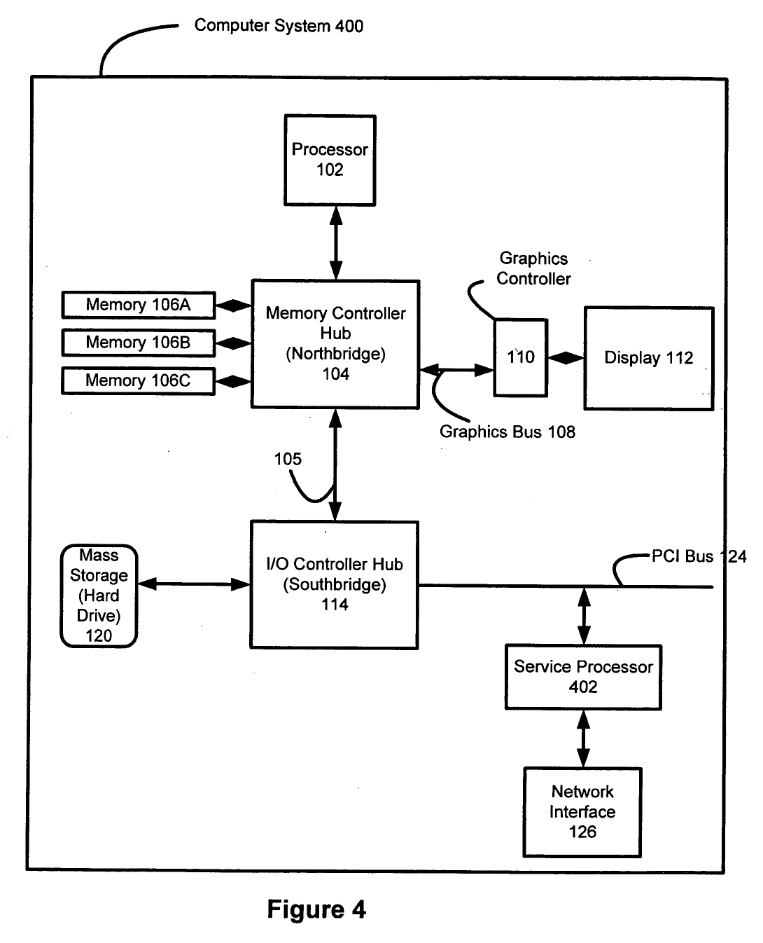

A computer system similar to that described with reference to FIG. 1 is now illustrated in FIG. 4. Computer system 400 is similar to computer system 100, except computer system 400 also includes a service processor 402. The service processor 402 can be used in various ways, including accessing the computer system 400 when the system in down due to the failure of some component such as processor 102, or a software component, such as the operating system or the VMM 240.

In one embodiment of the present invention, the service processor 402 is positioned such that data passes through the service processor 402 as it arrives from the network interface 126 or is passed to the network interface 126. In general, service processor 402 may be implemented as a separate component (as shown in FIG. 4), or integrated into another component. For example, in one embodiment, the service processor 402 and the network interface 126 are co-located on the same NIC. In another embodiment, the service processor 402 is integrated into the I/O controller hub 114.

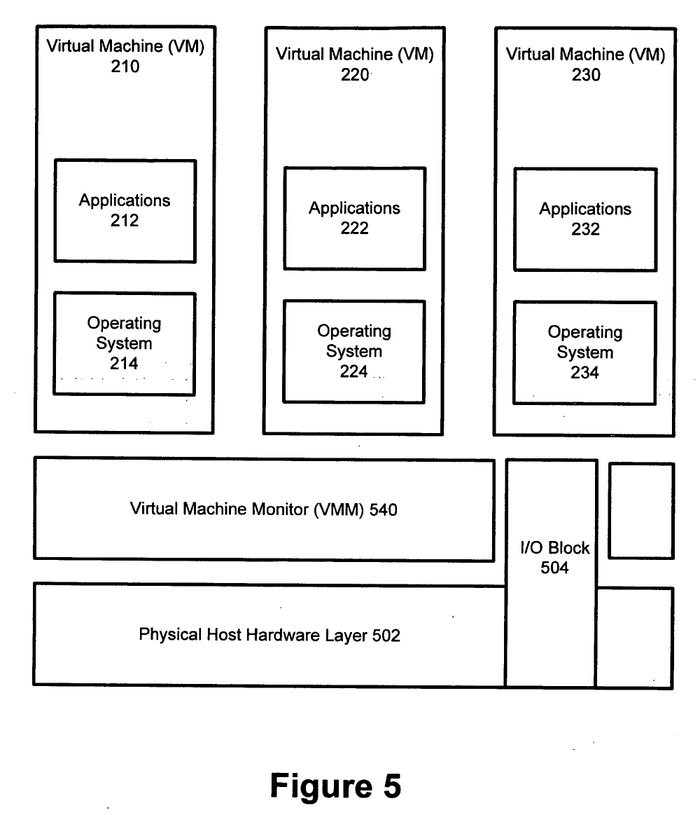

FIG. 5 illustrates a system architecture according to one embodiment of the invention. In one embodiment, the service processor 402 is used to provide multiple virtual instances of the network interface 126 even though only one physical network interface is included in computer system 400. This is done by the service processor tunneling through the VMM to provide one virtual instance of the network interface 126 for each VM, as shown in FIG. 5. From the viewpoint of a given VM, its corresponding virtual instance appears to be a dedicated network interface, such as its own NIC.

The system configuration shown in FIG. 5 is similar to that shown in FIG. 2. However, the physical host hardware layer 502 in FIG. 5 also includes the service processor 402 (Please show a service processor 402 in a dashed box inside of physical host hardware layer 502). Part of the functionality of the service processor 402 is to allow the input/output block 504 to tunnel through the VMM 540, which in turn is relieved of the network access management obligation. In one embodiment, an I/O block 504 provides a virtual instance of the network interface for each VM. Thus, to each VM it appears that it has its own network interface with its own device identifier, device number, and configuration status registers.

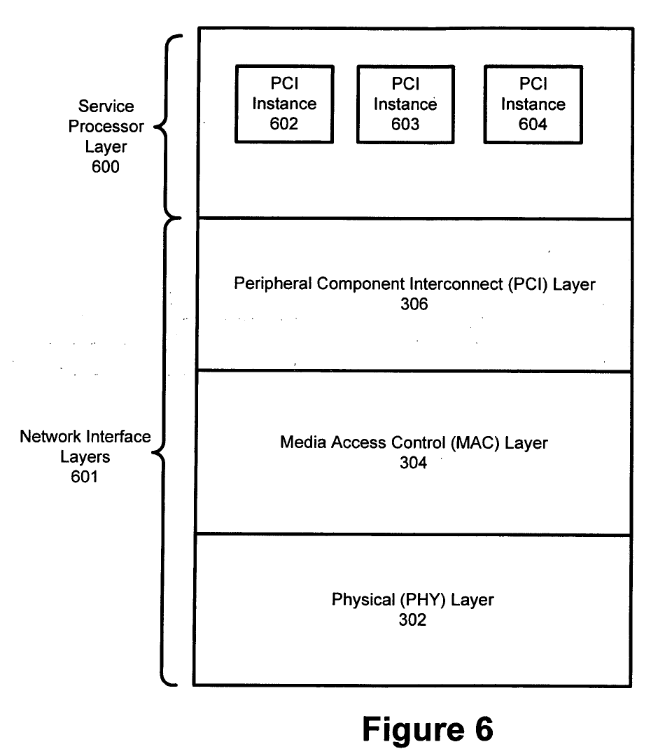

The I/O block 504 of FIG. 5 is now described in detail with reference to FIG. 6. The I/O block 504 still includes the traditional PHY, MAC, and PCI layers described with reference to FIG. 3. In addition, a service processor layer 600 is positioned on top of the PCI layer 306. The service processor layer 600 implemented by the service processor 402 in FIG. 4 is responsible, in one embodiment, for providing multiple PCI instances, such as depicted by PCI instances 602-604.

In one embodiment, each PCI instance is assigned to a VM. For example, VM 210 is assigned PCI instance 602, VM 220 is assigned PCI instance 603, and VM 230 is assigned PCI instance 604. Thus, to VM 210 it appears that it has unrestricted access to a network interface through PCI instance 602. The VMs access the network interface layers through their assigned PCI interface.

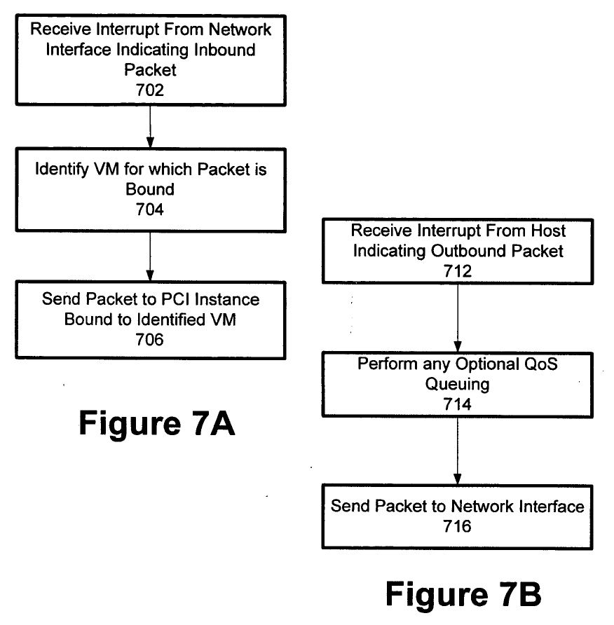

In one embodiment, each PCI interface 602-604 has a unique virtual MAC address as required by the Ethernet networking protocol. Each VM 210, 220, 230 has a unique IP address as required by the TCP/IP networking protocol. The process for handling inbound and outbound data traffic through the service processor layer 600 is now described with reference to FIGS. 7A and 7B respectively.

In FIG. 7A, inbound data communication commences when the service processor layer 600 receives an interrupt from the network interface 126, in block 702, indicating that there is a packet of data from the network that was received by the network interface that is destined for one of the VMs implemented by the computer system. The network interface itself need not be aware that there are multiple VMs being implemented, and comprise an off-the-shelf NIC.

In block 704, the service processor layer 600 reads the packet and identifies the VM for which it is destined. In one embodiment, each VM has an associated VM identifier (ID). The VM ID may be globally unique or unique on the host level. In one embodiment, the VM is identified using the VM identifier (ID) contained in the packet.

In one embodiment, the VM ID is bound to an associated PCI interface. For each PCI interface, there will be a set of information, including the MAC address, effective line-rate, and other properties corresponding to a channel associated with the PCI interface. In one embodiment, the service processor will provide one such channel for each virtual instance of the network interface provided. In one embodiment, each channel is specified by a 4-tuple including the PCI interface, VM ID of the VM associated with the PCI interface, the virtual MAC address assigned to the VM, and the line rate of the channel.

After the target VM is identified, the inbound packet is sent to the PCI interface bound to the identified VM in block 706, as explained above. The PCI interface represents a virtualized hardware instance of the network interface. Thus, the VM can read the packet from the PCI interface to which the packet was sent as if the VM were receiving the packet directly from a network interface.

In FIG. 7B, outbound data communication commences when the service processor layer 600 receives an interrupt from the host computer system, in block 712, indicating that there is a packet of data being transmitted by one of the VMs. In one embodiment, in block 714, the service processor layer 600 performs various Quality of Service (QoS) queuing, if the separate virtualized network interface instances (i.e., PCI instances) are provided at different speeds. However, the service processor layer 600 provides no such QoS distinctions in another embodiment of the present invention.

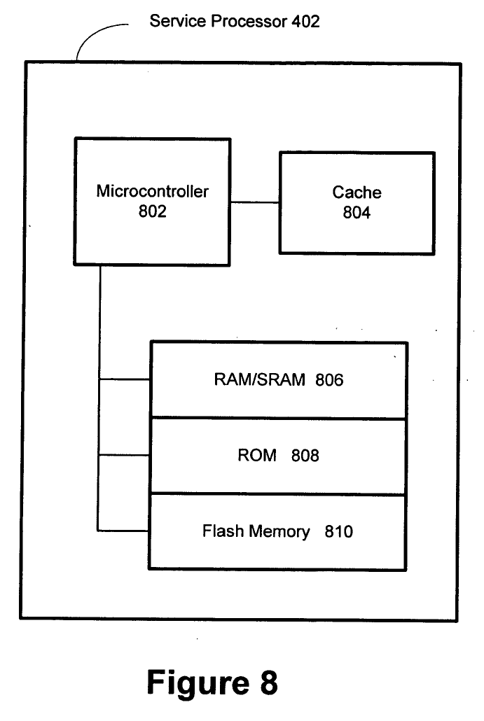

In block 716, the service processor layer 600 pushes the packet to the network interface 126, which in turn puts the packet out on the network pursuant to normal functioning of the network interface. One embodiment of the service processor 402 that can be configured to perform the tasks described as being allocated to the service processor layer 600 is now described with reference to FIG. 8.

In one embodiment, the service processor 402 includes a microcontroller 802 that operates as the CPU of the service processor 402. The microcontroller 802 executes a service processor operating system, which may be stored in ROM 808. The service processor 402 includes one or more of the memory units shown in FIG. 8, such as RAM and/or SRAM 806 and non-volatile flash memory 810. Other memories may also be included. The memories can be used to store (i.e., buffer) data packets being transmitted through the service processor layer 600, configuration information, databases and tables that maintain the virtual hardware instances of the network interface, CSR's (Control Status Registers) for the virtual PCI instances, and other data related to other activities carried out by the service processor 402.

In one embodiment, the service processor 402 also includes a cache 804. The cache 804 can be used to queue data packets being transmitted through the service processor layer 600 and to increase the efficiency of the microcontroller using well-known caching techniques.

General Matters

In the description above, for the purposes of explanation, numerous specific details have been set forth. However, it is understood that embodiments of the invention may be practiced without these specific details. In other instances, well-known circuits, structures and techniques have not been shown in detail in order not to obscure the understanding of this description.

Embodiments of the present invention include various processes. The processes may be performed by hardware components or may be embodied in machine-executable instructions, which may be used to cause one or more processors programmed with the instructions to perform the processes. Alternatively, the processes may be performed by a combination of hardware and software.

Aspects of some of the embodiments of the present invention may be provided as a coded instructions (e.g., a computer program, software/firmware module, etc.) that may be stored on a machine-readable medium, which may be used to program a computer (or other electronic device) to perform a process according to one or more embodiments of the present invention. The machine-readable medium may include, but is not limited to, floppy diskettes, optical disks, compact disc read-only memories (CD-ROMs), and magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a packet from a hardware network interface at a service processor of a host computer system;
identifying a first virtual machine of a plurality of virtual machines being implemented by the host computer system, the received packet being destined for the first virtual machine;
forwarding the packet to a first virtual instance of a plurality of virtual instances of the hardware network interface provided by the service processor, the first virtual instance of the hardware network interface being bound to the first virtual machine.

2. The method of claim 1, wherein the hardware network interface comprises a network interface card (NIC).

3. The method of claim 1, wherein identifying the first virtual machine includes observing that a virtual machine identifier contained in the received packet corresponds to a virtual machine identifier associated with the first virtual machine.

4. The method of claim 3, wherein forwarding the packed to the first virtual instance of the hardware network interface includes identifying a Peripheral Component Interconnect (PCI) instance associated with the virtual machine identifier.

5. The method of claim 4, wherein forwarding the packet to the first virtual instance of the hardware network interface further includes updating a destination media access control (MAC) address of the received packet to correspond to a virtual MAC address associated with the first virtual machine by the PCI instance.

6. The method of claim 1, further comprising providing the packet from the first virtual instance of the hardware network interface directly to the first virtual machine.

7. A service processor comprising:
a first interface to connect to a network interface card;
a second interface to connect to a host computer system;
a microcontroller; and
an instruction store, to provide a plurality of instructions to be executed on the microcontroller to effect a plurality of virtual instances of the network interface card, each of the plurality of virtual instances being bound to one of a plurality of virtual machines implemented by the host computer system.

8. The service processor of claim 7, wherein execution of the instructions further effect a Peripheral Component Interconnect (PCI) instance for each virtual instance of the network interface card.

9. The service processor of claim 7, wherein the service processor resides on the network interface card.

10. The service processor of claim 7, wherein each virtual machine directly accesses the virtual instance of the network interface card to which it is bound.

11. A machine-readable medium having stored thereon data representing instructions that, when executed by a service processor of a host computer system, cause the service processor to perform operations comprising:
receiving a packet from a hardware network interface of the host computer system;
identifying a first virtual machine of a plurality of virtual machines being implemented by the host computer system, the received packet being destined for the first virtual machine;
forwarding the packet to a first virtual instance of a plurality of virtual instances of the hardware network interface, the first virtual instance of the hardware network interface being bound to the first virtual machine.

12. The machine-readable medium of claim 11, wherein the hardware network interface comprises a network interface card (NIC).

13. The machine-readable medium of claim 11, wherein identifying the first virtual machine includes observing that a virtual machine identifier contained in the received packet corresponds to a virtual machine identifier associated with the first virtual machine.

14. The machine-readable medium of claim 13, wherein forwarding the packed to the first virtual instance of the hardware network interface includes identifying a Peripheral Component Interconnect (PCI) instance associated with the virtual machine identifier.

15. The machine-readable medium of claim 14, wherein forwarding the packet to the first virtual instance of the hardware network interface further includes updating a destination media access control (MAC) address of the received packet to correspond to a virtual MAC address associated with the first virtual machine by the PCI instance.

16. The machine-readable medium of claim 11, wherein execution of the instructions further cause the service processor to provide the packet from the first virtual instance of the hardware network interface directly to the first virtual machine.

17. A computer system comprising:
a central processor to execute software to implement a plurality of virtual machines;
a network interface card to connect the computer system to a network; and
a service processor coupled to the network interface card to implement a plurality of virtual instances of the network interface card, each of the plurality of virtual instances being bound to a respective one of the plurality of virtual machines implemented by the computer system.

18. The computer system of claim 17, wherein the service processor further comprises a memory to provide a Peripheral Component Interconnect (PCI) instance for each virtual instance of the network interface card.

19. The computer system of claim 7, wherein the service processor and the network interface card comprises a single physical component.

20. The computer system of claim 17, wherein each virtual machine directly accesses the virtual instance of the network interface card to which it is bound.
